(19) United States
(12) Patent Application Publication
(10) Pub. No.: US 2025/0142246 A1
(43) Pub. Date: May 1, 2025

(54) EAR CAP AND EARPHONE

(71) Applicant: Anker Innovations Technology Co., Ltd., Changsha (CN)

(72) Inventors: Xia Nie, Shenzhen (CN); Guoming SONG, Shenzhen (CN); Fan ZHOU, Shenzhen (CN)

(21) Appl. No.: 19/010,444

(22) Filed: Jan. 6, 2025

Related U.S. Application Data
(63) Continuation of application No. PCT/CN2023/107517, filed on Jul. 14, 2023.

(30) Foreign Application Priority Data
Jul. 15, 2022 (CN) 202210840205.5
Jul. 15, 2022 (CN) 202221833290.4
Jul. 15, 2022 (CN) 202221841303.2

(51) Int. Cl. H04R 1/10

(52) U.S. Cl. CPC H04R 1/1083; H04R 1/1016; H04R 2460/11

(57) ABSTRACT

Disclosed are an earphone and an ear cap applied to the earphone. The ear cap includes a main body and a noise reduction portion, and the main body is provided with an accommodating space and a sound outlet channel in communication with the accommodating space. At least part of the noise reduction portion is located in the accommodating space, an outer diameter of the noise reduction portion decreases along a sound outlet direction, and a noise reduction cavity is formed between an outer side wall of the noise reduction portion and an inner side wall of the main body. The ear cap adopts a double sealing structure of the main body and the noise reduction portion, which can greatly enhance a thickness of the ear cap, so that the ear cap has improved noise reduction performance.

### CROSS-REFERENCE TO RELATED APPLICATIONS

The present disclosure claims the priority of Chinese patent application No. 202210840205.5, filed on Jul. 15, 2022 before the China National Intellectual Property Administration of the People's Republic of China, entitled “Ear Cap and Earphone”; Chinese patent application No. 202221833290.4, filed on Jul. 15, 2022 before the China National Intellectual Property Administration of the People's Republic of China, entitled “Ear Cap and Earphone”; and Chinese patent application No. 202221841303.2, filed on Jul. 15, 2022 before the China National Intellectual Property Administration of the People's Republic of China, entitled “Ear Cap and Earphone”, which are incorporated herein by reference in their entirety.

### TECHNICAL FIELD

The present disclosure relates to the field of earphones, particularly to an ear cap and an earphone.

### BACKGROUND ART

There are two main types of earphones: in-ear earphones, and over-ear earphones. An in-ear earphone typically comes with an ear cap fitted onto the earphone body. The in-ear earphone usually isolates external noise using a sealing method. When the ear cap of the in-ear earphone is inserted into an ear canal of a user, a closed cavity is formed between the ear cap and the ear canal. However, due to the thin construction of the ear cap, external noise may penetrate through the ear cap and reach the user's ear.

### SUMMARY

The present disclosure provides an ear cap and an earphone, which can effectively prevent external noise from penetrating the ear cap and entering the ear canal of a user.

In a first aspect, the present disclosure provides an ear cap applied to an earphone. The earphone has an earphone body, the earphone body has a sound outlet pipe, and the sound outlet pipe has a sound channel. An end of the sound outlet pipe is provided with a sound outlet hole in communication with the sound channel; the ear cap comprising: a main body provided with an accommodating space and a sound outlet channel in communication with the accommodating space, the sound outlet channel being configured to communicate with the sound outlet hole of the sound outlet pipe; and a noise reduction portion, at least part of which is located in the accommodating space and an outer diameter of the noise reduction portion decreases along a sound outlet direction, wherein a noise reduction cavity is formed between an outer side wall of the noise reduction portion and an inner side wall of the main body.

In a second aspect, the present disclosure provides an earphone comprising an earphone body and an ear cap, wherein the earphone body has a sound outlet pipe, the sound outlet pipe has a sound channel, and an end of the sound outlet pipe is provided with a sound outlet hole in communication with the sound channel, wherein the sound outlet pipe extends into the accommodating space, the sound outlet hole is in communication with the sound outlet channel, and the noise reduction portion is disposed around a peripheral side of the sound outlet pipe.

Based on the ear cap and the earphone of the examples of the present disclosure, the ear cap adopts a double sealing structure of a combination of the main body and the noise reduction portion, which can greatly enhance a thickness of the ear cap, and the noise reduction cavity can increase a space or distance between the main body and the noise reduction portion, further improving the thickness of the ear cap. External noise needs to pass through the noise reduction portion, the noise reduction cavity and the main body to reach the user's ear. As noise enters the substantially sealed noise reduction cavity, it is gradually absorbed, distorted and attenuated by damping properties of the noise reduction cavity. This design ensures excellent noise reduction performance, effectively preventing external noise from penetrating the ear cap and entering the ear canal.

### BRIEF DESCRIPTION OF DRAWINGS

In order to more clearly illustrate examples of the disclosure or technical solutions in the related art, drawings that need to be used in description of the examples or the related art are briefly introduced below, and it will be apparent to those of ordinary skill in the art that the drawings in the following description are only some examples of the invention, and other drawings may be obtained in accordance with structures shown in these drawings without inventive work.

FIG. 1 is a schematic diagram in which an ear cap is fitted onto an earphone body according to a first example of the present disclosure;

FIG. 2 is a structure diagram of an ear cap according to a first example of the present disclosure;

FIG. 3 is a structure diagram of an ear cap according to a first example of the present disclosure;

FIG. 4 is a structure diagram of an ear cap according to a first example of the present disclosure;

FIG. 5 is a structure diagram of an earphone according to a first example of the present disclosure;

FIG. 6 is a schematic diagram of an overall structure of an earphone according to a second example of the present disclosure;

FIG. 7 is a cross-sectional structure diagram of an earphone according to a second example of the present disclosure;

FIG. 8 is a cross-sectional structure diagram of an earphone according to a second example of the present disclosure;

FIG. 9 is a cross-sectional structure diagram of an earphone according to a second example of the present disclosure; and

FIG. 10 is a cross-sectional structure diagram of an earphone according to a second example of the present disclosure.

### DETAILED DESCRIPTION

In order to make the purpose, technical solutions and advantages of the disclosure clearer, the disclosure will be described in more detail with reference to the attached drawings and examples. It should be understood that the specific examples described herein are only used to explain the disclosure and are not used to limit the disclosure.

### First Example

This example provides an ear cap and an earphone to solve a problem that the ear cap is generally has a thin construction and external noise easily penetrates the ear cap and enters the ear.

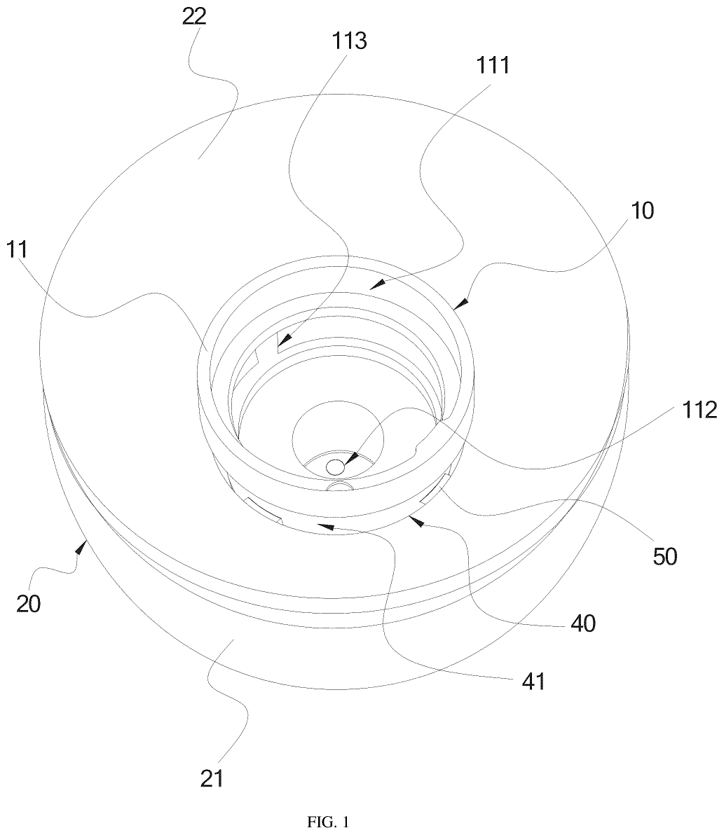

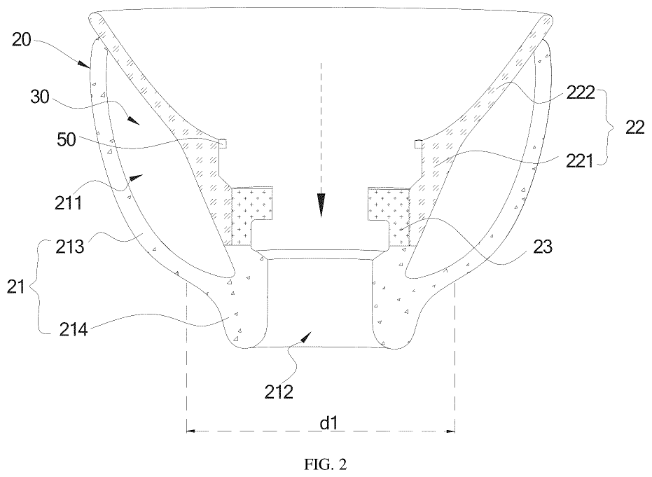

Specifically, as shown in FIG. 1 and FIG. 2, an ear cap 20 is applied to an earphone, the earphone has an earphone body 10, the earphone body 10 has a sound outlet pipe 11, the sound outlet pipe 11 has a sound channel 111, and an end of the sound outlet pipe 11 is provided with a sound outlet hole 112 in communication with the sound channel 111; the ear cap 20 includes a main body 21, an accommodating space 211 and a sound outlet channel 212 in communication with the accommodating space 211 are formed inside the main body 21, and the sound outlet channel 212 is configured to communicate with the sound outlet hole 112 of the sound outlet pipe 11. The overall shape of the main body 21 may be substantially bowl-shaped.

It should be noted that the earphone may be an in-ear wired earphone or wireless earphone, and the earphone body 10 may be in communication connection with a playing device such as a mobile phone, a notebook computer, a desktop computer, an MP3, and a wearable audio device. When the sound outlet pipe 11 is inserted into an ear canal of a user, the sound outlet hole 112 is located in the ear canal, and the sound played by the playing device may be transmitted to the ear canal through the sound channel 111 and the sound outlet hole 112 in sequence. A specific working principle of the earphone has been disclosed in the related art and is not repeated in the disclosure. The ear cap 20 can prevent direct contact between the ear canal and the sound outlet pipe 11, thereby avoiding potential injury and providing a comfortable wearing experience to people. The sound outlet channel 212 of the main body 21 is configured to be in communication with the sound outlet hole 112 of the earphone body 10, and when the sound outlet pipe 11 is inserted into the ear canal, the outer side of the main body 21 is in contact with the ear canal to form a closed cavity, and the sound transmitted from the sound outlet hole 112 may be transmitted to the ear canal through the sound outlet channel 212.

More specifically, the ear cap 20 further includes a noise reduction portion 22, at least part of the noise reduction portion 22 is located in the accommodating space 211, an outer diameter of the noise reduction portion 22 decreases along a sound outlet direction (as indicated by a dashed line arrow in FIG. 2), and a noise reduction cavity 30 is formed between an outer side wall of the noise reduction portion 22 and an inner side wall of the main body 21.

It should be noted that in the present disclosure, the ear cap 20 adopts a double sealing structure of the main body 21 and the noise reduction portion 22, which can greatly enhance a thickness of the ear cap 20, and the noise reduction cavity 30 can further improve the thickness of the ear cap 20. The external noise needs to pass through the noise reduction portion 22, the noise reduction cavity 30 and the main body 21 to enter the ear, and the noise is gradually absorbed, distorted and attenuated by damping properties of the noise reduction cavity 30 when entering the substantially airtight noise reduction cavity 30, so that the ear cap 20 has optimal noise reduction performance, and can effectively prevent the external noise from penetrating the ear cap 20 and entering the ear canal.

With reference to FIG. 1 and FIG. 2 again, the main body 21 includes a contact portion 213 and a sound outlet portion 214; the contact portion 213 has an accommodating space 211; the sound outlet portion 214 is connected to the contact portion 213 and has a sound outlet channel 212.

One end, close or proximal to the sound outlet channel, of the noise reduction portion 22 is connected or coupled to the sound outlet portion 214, and the noise reduction cavity 30 is jointly enclosed by the noise reduction portion 22, the contact portion 213 and the sound outlet portion 214, so that there is no air leakage gap between the noise reduction portion 22 and the sound outlet portion 214, thereby improving the airtightness of the noise reduction cavity 30.

With reference to FIG. 1 and FIG. 2 again, in some examples of the disclosure, the noise reduction portion 22 includes a first noise reduction section 221 and a second noise reduction section 222; the first noise reduction section 221 is connected to the sound outlet portion 214, the second noise reduction section 222 is located on an end of the first noise reduction section 221 away (e.g., distal) from the sound outlet portion 214 and is connected to the first noise reduction section 221, and the second noise reduction section 222 and the first noise reduction section 221 are disposed at an angle. It should be noted that the outer diameter of the noise reduction portion 22 decreases along the sound outlet direction, so that the second noise reduction section 222 expands outward relative to the first noise reduction section 221, and the second noise reduction section 222 and the first noise reduction section 221 are disposed at an angle, so that a joint between the second noise reduction section 222 and the first noise reduction section 221 can be concavely recessed inward, and a volume of the noise reduction cavity 30 can be increased, thereby improving a noise shielding effect, and a diameter of the first noise reduction section 221 is small, thereby improving in-ear comfort of the earphone. Meanwhile, when an end of the second noise reduction section 222 away or distal from the first noise reduction section 221 extends out of the accommodating space 211, the main body 21 can better support the second noise reduction section 222, so that the second noise reduction section 222 is not easily deformed.

Further, the angle formed between an outer side surface of the second noise reduction section 222 and an outer side surface of the first noise reduction section 221 is, for example, 150 degrees to 160 degrees. The angle formed between an outer side surface of the second noise reduction section 222 and an outer side surface of the first noise reduction section 221 may be a degree such as 150 degrees, 155 degrees, and 160 degrees. It can be understood that the larger the angle formed between the outer side surface of the second noise reduction section 222 and the outer side surface of the first noise reduction section 221, the larger the outer side surface of the second noise reduction section 222 expands outward relative to the outer side surface of the first noise reduction section 221. When the angle formed between the outer side surface of the second noise reduction section 222 and the outer side surface of the first noise reduction section 221 is too large, contact of the main body 21 with the ear canal is too tight, causing discomfort to the user. When the angle formed between the outer side surface of the second noise reduction section 222 and the outer side surface of the first noise reduction section 221 is too small, connection between the second noise reduction section 222 and the main body 21 is not tight enough, which easily leads to failure in sealing of the noise reduction cavity 30.

In an example of the disclosure, the noise reduction portion 22 may be integrally formed with the main body 21 to enhance connection strength between the noise reduction portion 22 and the main body 21 and prevent separation of the noise reduction portion 22 from the main body 21.

With reference to FIG. 1 and FIG. 2 again, in some examples of the disclosure, a joint between the contact portion 213 and the sound outlet portion 214 is concavely recessed inward; it should be noted that, referring to FIG. 2, when the sound outlet pipe 11 provided with the ear cap 20 is inserted into the ear canal, the sound outlet portion 214 is located at the front end of the ear cap 20 and thus deeper in the ear canal. In the present disclosure, the contact portion 213 ensures the airtightness when the sound outlet pipe 11 is inserted into the ear canal, and a necking design is made at the joint between the contact portion 213 and the sound outlet portion 214 to form a nipple-like structure without influencing normal use of the ear cap 20, which can reduce a contact area and an squeezing amount of the sound outlet portion 214 and the ear canal, reduce a sense of intrusion of the ear cap 20 to the ear canal, and improve in-ear comfort.

It should also be noted that, referring to FIG. 2, curvature of an outer contour of a longitudinal section of the contact portion 213 is greater than curvature of an outer contour of a longitudinal section of the sound outlet portion 214, that is, a bending degree of the outer side surface of the sound outlet portion 214 is greater than a bending degree of the outer side surface of the sound outlet portion 214 in the sound outlet direction, so that a reduction extent of an outer diameter of the contact portion 213 is greater than a reduction extent of an outer diameter of the sound outlet portion 214 in the sound outlet direction, thereby forming an inward recessed structure at the joint between the contact portion 213 and the sound outlet portion 214.

Specifically, the outer diameter of the sound outlet portion 214 decreases along a direction from the contact portion 213 toward the sound outlet portion 214, and it can be understood that an area of the sound outlet portion 214 farther from the contact portion 213 has a smaller outer diameter, and an outer diameter of the joint between the sound outlet portion 214 and the contact portion 213 is a maximum diameter of the sound outlet portion 214. Therefore, when the sound outlet pipe 11 mounted with the ear cap 20 is inserted into the ear canal, an area of the sound outlet portion 214 inserted deeper into the ear canal has a smaller outer diameter, which can further reduce the sense of invasion of the ear cap 20 to the ear canal and improve the in-ear comfort.

It should be further noted that the outer side surface of the sound outlet portion 214 may be a curved surface or an inclined plane, and when the outer side surface of the sound outlet portion 214 is an inclined plane, an angle formed between the outer side surface of the sound outlet portion 214 and the sound outlet direction of the ear cap 20 may be 15 degrees to 20 degrees, and may be 15 degrees, 17 degrees, 18 degrees, 20 degrees, or the like; when the angle formed between the outer side surface of the sound outlet portion 214 and the sound outlet direction of the ear cap 20 is too small, a maximum outer diameter of the sound outlet portion 214 is large, thereby causing a strong squeezing to the ear canal; and when the angle formed between the outer side surface of the sound outlet portion 214 and the sound outlet direction of the ear cap 20 is too large, a maximum outer diameter of the sound outlet portion 214 is too small, the sound outlet channel 212 becomes small, and the sound outlet channel 212 is easily closed when the sound outlet portion 214 is squeezed.

In an example of the present disclosure, the outer diameter of the contact portion 213 decreases along the direction from the contact portion 213 toward the sound outlet portion 214, that is, an area of the contact portion 213 that is closer to the sound outlet portion 214 has a smaller outer diameter, so as to reduce the contact area and the squeezing amount of the contact portion 213 and the ear canal, reduce the sense of invasion of the ear cap 20 to the ear canal, and improve the in-ear comfort. At this time, the outer diameter of the joint between the contact portion 213 and the sound outlet portion 214 is a minimum outer diameter of the contact portion 213, and the outer side surface of the contact portion 213 may be a curved surface or an inclined plane.

In some examples, the outer diameter of the contact portion 213 may be the same along the direction from the contact portion 213 toward the sound outlet portion 214, so as to improve the airtightness of the ear cap 20 in the ear canal.

With reference to FIG. 2 again, in some examples of the disclosure, an outer diameter of the joint between the contact portion 213 and the sound outlet portion 214 is d1 that is 6 mm to 7 mm. d1 may be 6 mm, 6.5 mm, 7 mm, or the like. d1 that is too large may cause strong squeezing effect to the ear canal to cause discomfort of the user; d1 that is too small may cause a reduced size of the sound outlet 212, and easily cause the sound outlet channel 212 to be closed when the sound outlet portion 214 is squeezed.

With reference to FIG. 2 again, in some examples of the disclosure, the contact portion 213 is in smooth connection with the sound outlet portion 214.

With reference to FIG. 2 again, in some examples of the disclosure, the ear cap 20 further includes a mounting portion 23 located in the accommodating space 211, the mounting portion 23 is connected to an end of the sound outlet portion 214 close or proximal to the noise reduction portion 22, and the noise reduction portion 22 is disposed around a peripheral side of the mounting portion 23. It should be noted that the ear cap 20 may be mounted on the sound outlet pipe 11 through the mounting portion 23.

Further, a hardness of a material for preparing the mounting portion 23 is greater than a hardness of a material for preparing the main body 21. It should be noted that when the sound outlet pipe 11 provided with the ear cap 20 is inserted into the ear canal, the main body 21 is in contact with the ear canal, the material for preparing the main body 21 is soft, which can reduce discomfort of the ear canal, prevent the main body 21 from damaging the ear canal, and improve the in-ear comfort. The hardness of the mounting portion 23 is greater, which can improve connection strength between the mounting portion 23 and the sound outlet pipe 11, so that the ear cap 20 is not prone to fall into the ear canal when the sound outlet pipe 11 is inserted into the ear canal. Both the material for preparing the mounting portion 23 and the material for preparing the main body 21 may be silica gel, the hardness of the material for preparing the mounting portion 23 is greater than or equal to 60 A, and the hardness of the material for preparing the main body 21 is 20 A to 30 A.

As shown in FIG. 2, in an example of the disclosure, an end of the noise reduction portion 22 away or distal from the sound outlet channel 212 extends out of the accommodating space 211, and an end of the main body 21 away or distal from the sound outlet channel 212 abuts against an outer side wall of the noise reduction portion 22. The noise reduction portion 22 may be supported by the end of the main body 21 away or distal from the sound outlet channel 212, so that the noise reduction portion 22 is not prone to be deformed, and the end of the main body 21 away or distal from the sound outlet channel 212 is in close contact with the outer side wall of the noise reduction portion 22, so as to ensure the airtightness of the noise reduction cavity 30 and facilitate attachment and detachment of the noise reduction portion 22 in a case where the noise reduction portion 22 is detachable; where a length of the end of the noise reduction portion 22 away or distal from the sound outlet channel 212 extending out of the accommodating space 211 can be selected according to actual needs.

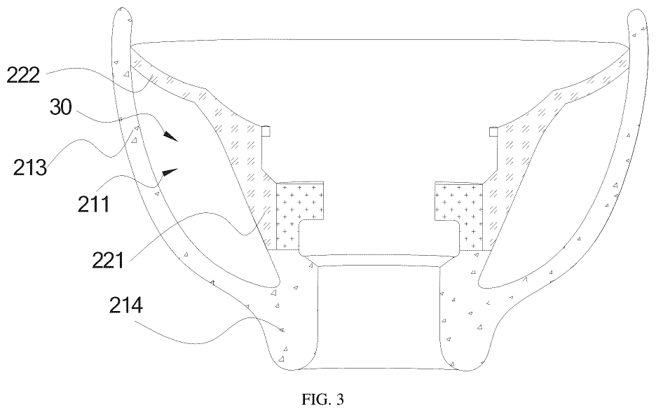

As shown in FIG. 3, the noise reduction portion 22 may be located in the accommodating space 211, and the end of the noise reduction portion 22 away or distal from the sound outlet channel 212 abuts against an inner side wall of the main body 21, which can prevent a situation in which the ear cap 20 is squeezed such that an edge of the noise reduction portion 22 is tilted to cause failure in sealing of the noise reduction cavity 30 during use of the earphone body 10.

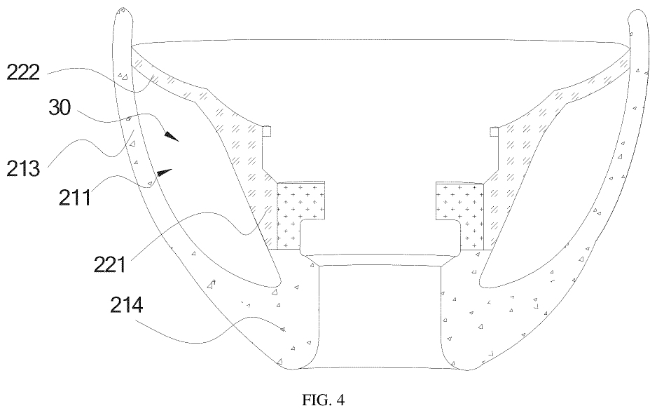

It should also be noted that FIG. 2 and FIG. 3 only illustrate the case of necking design at the joint between the contact portion 213 and the sound outlet portion 214, and as shown in FIG. 4, the joint between the contact portion 213 and the sound outlet portion 214 may protrude outward.

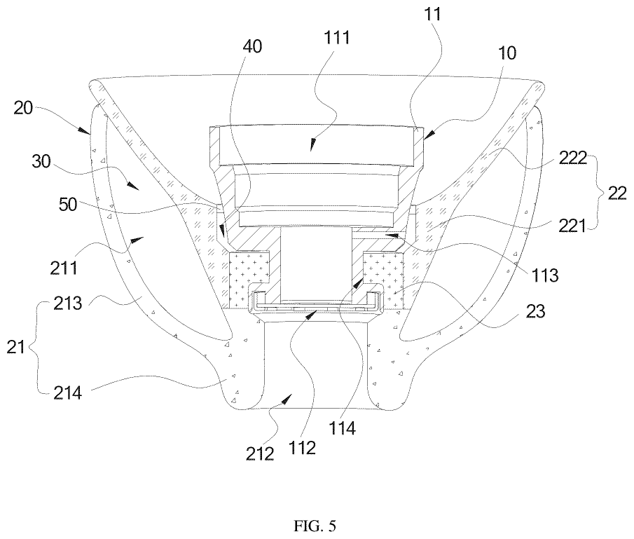

Based on the ear cap 20, the present disclosure further provides an earphone. As shown in FIG. 5, the earphone includes the earphone body 10 and the ear cap 20 according to any one of the above examples, in which the earphone body 10 has a sound outlet pipe 11, the sound outlet pipe 11 has a sound channel 111, and an end of the sound outlet pipe 11 is provided with a sound outlet hole 112 in communication with the sound channel 111.

The sound outlet pipe 11 extends into the accommodating space 211, the sound outlet hole 112 is in communication with the sound outlet channel 212, and the noise reduction portion 22 is disposed around a peripheral side of the sound outlet pipe 11.

Specifically, with reference to FIG. 5 again, a side of the sound outlet pipe 11 may be provided with a pressure relief hole 113 in communication with the sound channel 111. It can be understood that when the sound outlet pipe 11 is inserted into the ear canal and the outer side of the main body 21 is in contact with the ear canal, a closed cavity is formed between the ear cap 20 and the ear canal to isolate noise outside by sealing effect. However, when the sound outlet pipe 11 is inserted into the ear canal, sound quality is damaged due to uneven sound pressure inside and outside the sound channel 111 when a hearing environment is sealed, and the pressure relief hole 113 can communicate the sound channel 111 with the atmosphere, so that the sound pressure inside and outside the sound channel 111 can be kept the same.

In an example of the present disclosure, a pressure relief cavity 40 is formed between the noise reduction portion 22 and the sound outlet pipe 11, the pressure relief cavity 40 communicates with the sound channel 111 through the pressure relief hole 113, and the pressure relief cavity 40 has a pressure relief port 41 (as shown in FIG. 1). It should be noted that the pressure relief cavity 40 is always in communication with the atmosphere through the pressure relief port 41, and when the sound outlet pipe 11 is inserted into the ear canal, the sound channel 111 can be in communication with the atmosphere through the pressure relief hole 113 and the pressure relief cavity 40, so that the sound pressure inside and outside the sound channel 111 can be kept the same.

Further, a support portion 50 may be provided between the noise reduction portion 22 and the sound outlet pipe 11, and is located in the pressure relief cavity 40; and the support portion 50 is used to support between the noise reduction portion 22 and the sound outlet pipe 11 to maintain the presence of the pressure relief cavity 40, thereby preventing the main body 21 and the noise reduction portion 22 from being squeezed when the sound outlet pipe 11 is inserted into the ear canal to cause the pressure relief cavity 40 to be closed.

A plurality of supporting portions 50 that may be arranged at intervals around the peripheral side of the sound outlet pipe 11, and the pressure relief port 41 is formed between two adjacent supporting portions 50 (as shown in FIG. 1). A plurality of supporting portions 50 are arranged on the peripheral side of the sound outlet pipe 11, thereby further preventing the main body 21 and the noise reduction portion 22 from being squeezed when the sound outlet pipe 11 is inserted into the ear canal to cause the pressure relief cavity 40 to be closed. Further, a plurality of supporting portions 50 may be arranged evenly around the peripheral side of the sound outlet pipe 11.

With reference to FIG. 5 again, in some examples of the present disclosure, the outer side of the sound outlet pipe 11 is provided with a first clamping groove 114, and the mounting portion 23 is clamped in the first clamping groove 114. The connection between the ear cap 20 and the sound outlet pipe 11 can be realized by clamping of the mounting portion 23 to the first clamping groove 114, so as to prevent separation of the ear cap 20 from the sound outlet pipe 11.

Further, a hardness of a material for used for the mounting portion 23 is greater than a hardness of a material used for the main body 21. It should be noted that when the sound outlet pipe 11 is inserted into the ear canal, the main body 21 is in contact with the ear canal, the material for preparing the main body 21 is soft, which can reduce discomfort of the ear canal, prevent the main body 21 from damaging the ear canal, and improve the in-ear comfort, and the hardness of the mounting portion 23 is large, which can improve connection strength between the mounting portion 23 and the sound outlet pipe 11, so that the main body 21 is not prone to fall into the ear canal when the sound outlet pipe 11 is inserted into the ear canal; both the material for preparing the mounting portion 23 and the material for preparing the main body 21 may be silica gel, the hardness of the material for preparing the mounting portion 23 is greater than or equal to 60 A, and the hardness of the material for preparing the main body 21 is 20 A to 30 A.

In an example of the disclosure, the noise reduction portion 22 may be sleeved on the mounting portion 23 to maintain the presence of the pressure relief cavity 40 through the mounting portion 23.

In some examples of the disclosure, an end of the noise reduction portion 22 close or proximal to the sound outlet channel 212 may be spaced apart from the main body 21, and the noise reduction cavity 30 is jointly enclosed by the noise reduction portion 22, the main body 21 and the sound outlet pipe 11.

### Second Example

This example provides an earphone to solve a problem that an ear cap component is generally thin and external noise easily penetrates the ear cap component and enters the ear.

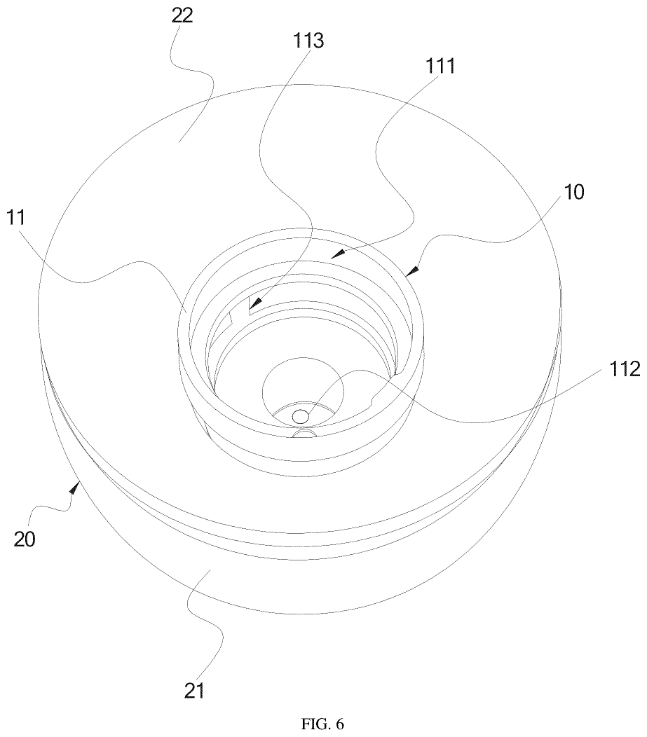

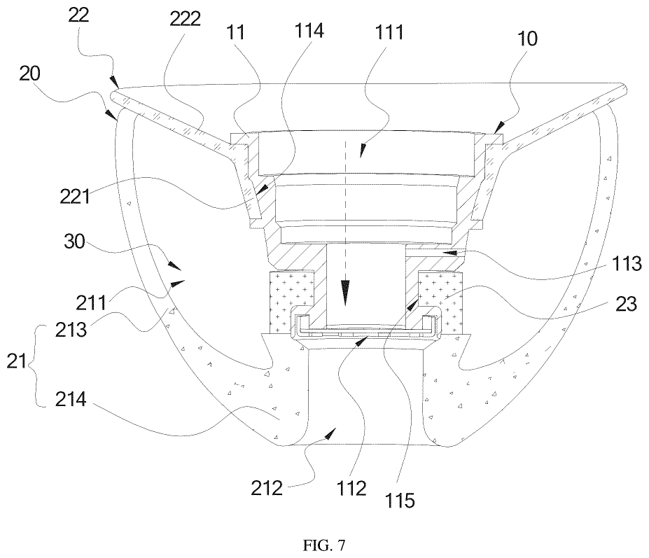

As shown in FIG. 6 and FIG. 7, the earphone provided in the disclosure includes an earphone body 10 (equivalent to the earphone body 10 in First Example) and an ear cap component 20 (equivalent to the ear cap 20 in First Example), the earphone body 10 has a sound outlet pipe 11 (equivalent to the sound outlet pipe 11 in First Example), the sound outlet pipe 11 has a sound channel 111 (equivalent to the sound channel 111 in First Example), and an end of the sound outlet pipe 11 is provided with a sound outlet hole 112 (equivalent to the sound outlet hole 112 in First Example) in communication with the sound channel 111; the ear cap component 20 includes an ear cap body 21 (equivalent to the main body 21 in First Example), the ear cap body 21 has an accommodating space 211 (equivalent to the accommodating space 211 in First Example) and a sound outlet channel 212 (equivalent to the sound outlet channel 212 in First Example) in communication with the accommodating space 211, the sound outlet pipe 11 extends into the accommodating space 211, and the sound outlet hole 112 is in communication with the sound outlet channel 212. The overall shape of the ear cap main body 21 may be substantially bowl-shaped.

It should be noted that the earphone may be an in-ear wired earphone or wireless earphone, and the earphone body 10 may be in communication connection with a playing device such as a mobile phone, a notebook computer, a desktop computer, an MP3, and a wearable audio device. When the sound outlet pipe 11 is inserted into an ear canal of a user, the sound outlet hole 112 is located in the ear canal, and the sound played by the playing device may be transmitted to the ear canal through the sound channel 111 and the sound outlet hole 112 in sequence. A specific working principle of the earphone has been disclosed in the related art and is not repeated in the disclosure. The ear cap component 20 can prevent direct contact between the ear canal and the sound outlet pipe 11, thereby avoiding potential injury and and providing a comfortable wearing experience to people. The sound outlet channel 212 of the ear cap main body 21 is configured to be in communication with the sound outlet hole 112 of the earphone body 10, and when the sound outlet pipe 11 is inserted into the ear canal, the outer side of the ear cap main body 21 is in contact with the ear canal to form a closed cavity, and the sound transmitted from the sound outlet hole 112 may be transmitted to the ear canal through the sound outlet channel 212.

More specifically, the ear cap component 20 further includes a noise reduction member 22 (equivalent to the noise reduction portion 22 in First Example), at least part of the noise reduction member 22 is located in the accommodating space 211, the noise reduction member 22 is sleeved on the sound outlet pipe 11, and the noise reduction member 22, the sound outlet pipe 11 and the ear cap main body 21 enclose to form a noise reduction cavity 30 (equivalent to the noise reduction cavity 30 in First Example).

It should be noted that in the present disclosure, the ear cap component 20 adopts a double sealing structure of the ear cap main body 21 and the noise reduction member 22, which can greatly improve a thickness of the ear cap component 20, and the noise reduction cavity 30 can further improve the thickness of the ear cap component 20. The external noise needs to pass through the noise reduction member 22, the noise reduction cavity 30 and the ear cap main body 21 to enter the ear, and the noise is gradually absorbed, distorted and attenuated by damping properties of the noise reduction cavity 30 when entering the substantially airtight noise reduction cavity 30, so that the ear cap component 20 has good noise reduction performance, and can effectively prevent the external noise from penetrating the ear cap component 20 and entering the ear canal.

Further, the noise reduction member 22 is detachably connected to the ear cap body 21 and the earphone body 10, so as to facilitate detachment and replacement thereof. It should be noted that, in the disclosure, the noise reduction member 22 and the ear cap body 21 are independent members, and the noise reduction member 22 may be freely detached and replaced, so that the noise reduction member 22 of an appropriate size may be selected according to the size of the ear canal of the user, and the in-ear comfort of the ear cap component 20 is improved.

With reference to FIG. 7 again, the ear cap body 21 includes a contact portion 213 (equivalent to the contact portion 213 in First Example) and a sound outlet portion 214 (equivalent to the sound outlet portion 214 in First Example); the contact portion 213 has the accommodating space 211; the sound outlet portion 214 is connected to the contact portion 213 and has a sound outlet channel 212. An end of the noise reduction member 22 close or proximal to the sound outlet channel 212 is spaced apart from the sound outlet portion 214, preventing the noise reduction member 22 from influencing mounting of the ear cap main body 21 and the sound outlet pipe 11.

With reference to FIG. 7 again, in some examples of the disclosure, the noise reduction member 22 includes a first noise reduction section 221 (equivalent to the first noise reduction section 221 in First Example) and a second noise reduction section 222 (equivalent to the second noise reduction section 222 in First Example); the first noise reduction section 221 is spaced apart from the sound outlet portion 214, the second noise reduction section 222 is located on a side of the first noise reduction section 221 away or distal from the sound outlet portion 214 and is connected to the first noise reduction section 221, and the second noise reduction section 222 and the first noise reduction section 221 are disposed at an angle. It should be noted that the outer diameter of the noise reduction member 22 decreases along the sound outlet direction (a direction indicated by a dashed line arrow in FIG. 7), so that the second noise reduction section 222 expands outward relative to the first noise reduction section 221, and the second noise reduction section 222 and the first noise reduction section 221 are disposed at an angle, so that a joint between the second noise reduction section 222 and the first noise reduction section 221 can be recessed inward, and a volume of the noise reduction cavity 30 can be increased, thereby improving a noise shielding effect, and a diameter of the first noise reduction section 221 is small, thereby improving in-ear comfort of the earphone. Meanwhile, when an end of the second noise reduction section 222 away or distal from the first noise reduction section 221 extends out of the accommodating space 211, the ear cap main body 21 can better support the second noise reduction section 222, so that the second noise reduction section 222 is not easily deformed.

Further, the angle formed between an outer side surface of the second noise reduction section 222 and an outer side surface of the first noise reduction section 221 is 150 degrees to 160 degrees. The angle formed between an outer side surface of the second noise reduction section 222 and an outer side surface of the first noise reduction section 221 may be a degree such as 150 degrees, 155 degrees, and 160 degrees. It can be understood that the larger the angle formed between the outer side surface of the second noise reduction section 222 and the outer side surface of the first noise reduction section 221, the larger the outer side surface of the second noise reduction section 222 expands outward relative to the outer side surface of the first noise reduction section 221. When the angle formed between the outer side surface of the second noise reduction section 222 and the outer side surface of the first noise reduction section 221 is too large, contact of the ear cap main body 21 with the ear canal is too tight to cause discomfort to the user, and when the angle formed between the outer side surface of the second noise reduction section 222 and the outer side surface of the first noise reduction section 221 is too small, connection between the second noise reduction section 222 and the ear cap main body 21 is not tight enough, which easily leads to failure in sealing of the noise reduction cavity 30.

It should be further noted that the first noise reduction section 221 and the second noise reduction section 222 may be integrally formed, or may be separately formed and then connected by means of clamping or gluing.

With reference to FIG. 7 again, in an example of the present disclosure, the outer side of the sound outlet pipe 11 is provided with a first clamping groove 114, and the first noise reduction section 221 is clamped to the first clamping groove 114. Through clamping of the first noise reduction section 221 to the first clamping groove 114, the noise reduction member 22 can be detachably connected with the sound outlet pipe 11 and can be prevented from separating from the sound outlet pipe 11. When the noise reduction member 22 is not needed, is damaged or needs to be used in different types, the noise reduction member 22 can be detached and replaced, and during use of the noise reduction member 22, the noise reduction member 22 can be prevented from moving up and down through fitting of the first noise reduction section 221 and the first clamping groove 114 to influence the use of the ear cap component 20.

Specifically, the first noise reduction section 221 may be in interference fit with the sound outlet pipe 11 to enhance the connection strength between the first noise reduction section 221 and the sound outlet pipe 11 during use of the noise reduction member 22 and prevent the noise reduction member 22 from separating from the sound outlet pipe 11 in use.

With reference to FIG. 7 again, in some examples of the disclosure, a side of the sound outlet pipe 11 may be provided with a pressure relief hole 113 (equivalent to the pressure relief hole 113 in First Example) in communication with the sound channel 111. It can be understood that when the sound outlet pipe 11 is inserted into the ear canal and the outer side of the ear cap main body 21 is in contact with the ear canal, a closed cavity is formed between the ear cap component 20 and the ear canal to isolate noise outside by sealing effect. However, when the sound outlet pipe 11 is inserted into the ear canal, sound quality is impacted due to uneven sound pressure inside and outside the sound channel 111 when a hearing environment is sealed, and the pressure relief hole 113 can communicate the sound channel 111 with the atmosphere, so that the sound pressure inside and outside the sound channel 111 can be kept the same.

Further, the pressure relief hole 113 is located between the noise reduction member 22 and the sound outlet portion 214, and the sound channel 111 is in communication with the noise reduction cavity 30 through the pressure relief hole 113. It may be understood that when the sound outlet pipe 11 is inserted into the ear canal, air in the sound channel 111 may be discharged into the noise reduction cavity 30 through the pressure relief hole 113 for a certain amount of pressure relief, so that the sound pressure inside and outside the sound channel 111 may be substantially kept the same.

With reference to FIG. 7 again, the ear cap component may further include a mounting portion 23 (equivalent to the mounting portion 23 in First Example), the mounting portion 23 is located in the accommodating space 211 and between the noise reduction member 22 and the sound outlet portion 214 and connected to the sound outlet portion 214; the outer side of the sound outlet pipe 11 is provided with a second clamping groove 115 (equivalent to the first clamping groove 114 in First Example), and the mounting portion 23 is clamped to the second clamping groove 115. It should be noted that the ear cap body 21 may be mounted on the sound outlet pipe 11 through the mounting portion 23.

Further, the pressure relief hole 113 is located between the mounting portion 23 and the noise reduction member 22. Specifically, the pressure relief hole 113 is located between the first noise reduction section 221 and the mounting portion 23, which can avoid the first noise reduction section 221 and the mounting portion 23 blocking the pressure relief hole 113.

In an example of the present disclosure, a hardness of a material used for preparing the mounting portion 23 is greater than a hardness of a material used for preparing the ear cap main body 21. It should be noted that when the sound outlet pipe 11 provided with the ear cap component 20 is inserted into the ear canal, the ear cap main body 21 is in contact with the ear canal, the material for preparing the ear cap main body 21 is soft, which can reduce discomfort of the ear canal, prevent the ear cap main body 21 from damaging the ear canal, and improve the in-ear comfort. The hardness of the mounting portion 23 is greater, which can improve connection strength between the mounting portion 23 and the sound outlet pipe 11, so that the ear cap component 20 is not prone to fall into the ear canal when the sound outlet pipe 11 is inserted into the ear canal. Both the material for preparing the mounting portion 23 and the material for preparing the ear cap main body 21 may be silica gel, the hardness of the material for preparing the mounting portion 23 is greater than or equal to 60 A, and the hardness of the material for preparing the ear cap main body 21 is 20 A to 30 A.

With reference to FIG. 7 again, in an example of the disclosure, a wall thickness of the first noise reduction section 221 is greater than a wall thickness of the second noise reduction section 222. It can be understood that a large wall thickness of the first noise reduction section 221 can ensure the structural strength of the first noise reduction section 221 and prevent the first noise reduction section 221 from being damaged, and a small wall thickness of the second noise reduction section 222 causes the second noise reduction section 222 to be easily deformed when being squeezed and prevents the second noise reduction section 222 from squeezing the ear canal.

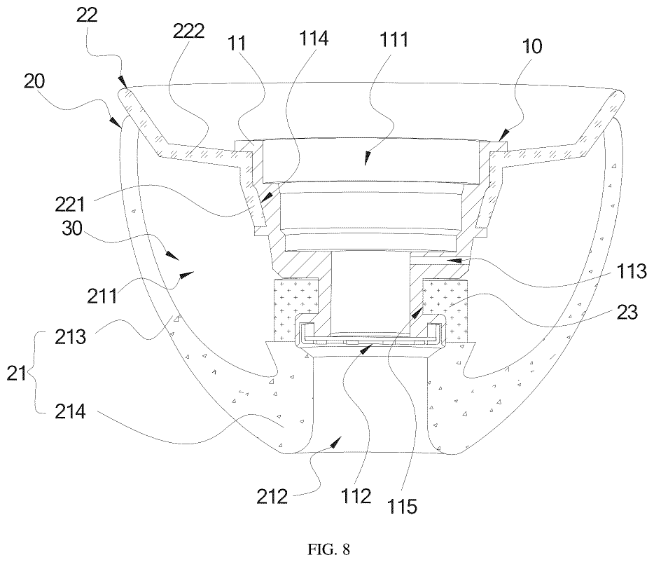

With reference to FIG. 7 again, the whole second noise reduction section 222 may extend only in one direction, that is, the second noise reduction section 222 is of a one-segment structure; of course, as shown in FIG. 8, the second noise reduction section 222 may also be composed of multiple segments connected to each other, and an extension direction of each of the segments may be different. With reference to FIG. 7 and FIG. 8 again, in an example of the disclosure, an end of the noise reduction member 22 away or distal from the sound outlet channel 212 extends out of the accommodating space 211, and an end of the ear cap main body 21 away or distal from the sound outlet channel 212 abuts against an outer side wall of the noise reduction member 22. The noise reduction member 22 may be supported by the end of the ear cap main body 21 away or distal from the sound outlet channel 212, so that the noise reduction member 22 is not prone to be deformed, and the end of the ear cap main body 21 away or distal from the sound outlet channel 212 is in close contact with the outer side wall of the noise reduction member 22, so as to ensure the airtightness of the noise reduction cavity 30 and facilitate attachment and detachment of the noise reduction member 22 in a case where the noise reduction member 22 is detachable; where a length of the end of the noise reduction member 22 away or distal from the sound outlet channel 212 extending out of the accommodating space 211 can be selected according to actual needs.

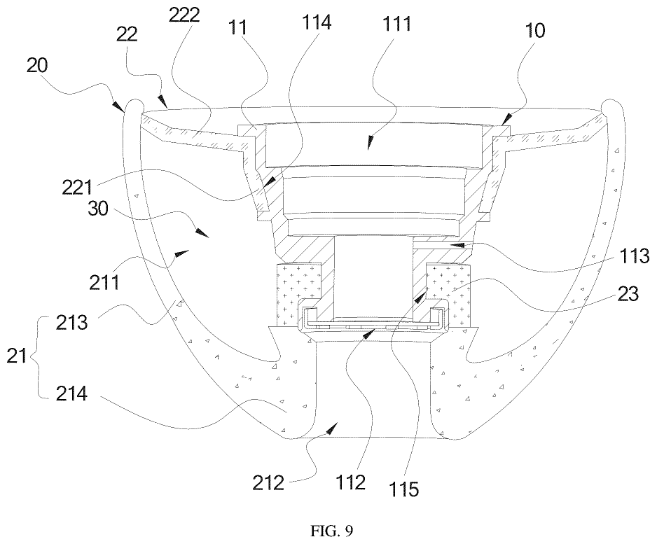

As shown in FIG. 9, the noise reduction member 22 may be located in the accommodating space 211, and the end of the noise reduction member 22 away or distal from the sound outlet channel 212 abuts against an inner side wall of the ear cap main body 21, which can prevent a situation in which the ear cap component 20 is squeezed such that an edge of the noise reduction member 22 is tilted to cause failure in sealing of the noise reduction cavity 30 during use of the earphone body 10.

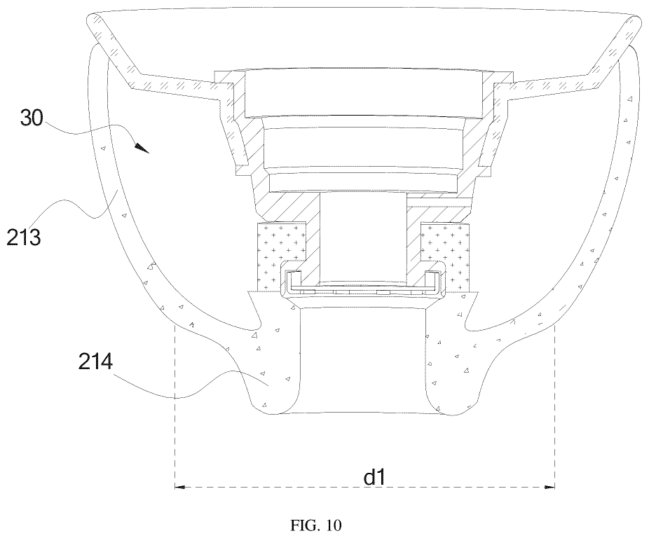

It should also be noted that FIG. 7 and FIG. 9 only illustrate cases where the joint between the contact portion 213 and the sound outlet portion 214 protrudes outward, and as shown in FIG. 10, the joint between the contact portion 213 and the sound outlet portion 214 may neck down.

Specifically, as shown in FIG. 10, a joint between the contact portion 213 and the sound outlet portion 214 is concavely recessed inward; it should be noted that, referring to FIG. 10, when the sound outlet pipe 11 provided with the ear cap component 20 is inserted into the ear canal, the sound outlet portion 214 is located at the front end of the ear cap component 20 and thus deeper in the ear canal. In the present disclosure, the contact portion 213 ensures the airtightness when the sound outlet pipe 11 is inserted into the ear canal, and a necking design is made at the joint between the contact portion 213 and the sound outlet portion 214 to form a nipple-like structure without influencing normal use of the ear cap component 20, which can reduce a contact area and an squeezing amount of the sound outlet portion 214 and the ear canal, reduce a sense of invasion of the ear cap component 20 to the ear canal, and improve in-ear comfort.

It should also be noted that, referring to FIG. 10, curvature of an outer contour of a longitudinal section of the contact portion 213 is greater than curvature of an outer contour of a longitudinal section of the sound outlet portion 214, that is, a bending degree of the outer side surface of the sound outlet portion 214 is greater than a bending degree of the outer side surface of the sound outlet portion 214 in the sound outlet direction, so that a reduction extent of an outer diameter of the contact portion 213 is greater than a reduction extent of an outer diameter of the sound outlet portion 214 in the sound outlet direction, thereby forming an inward recessed structure at the joint between the contact portion 213 and the sound outlet portion 214.

Specifically, the outer diameter of the sound outlet portion 214 decreases along a direction from the contact portion 213 toward the sound outlet portion 214, and it can be understood that an area of the sound outlet portion 214 farther from the contact portion 213 has a smaller outer diameter, and an outer diameter of the joint between the sound outlet portion 214 and the contact portion 213 is a maximum diameter of the sound outlet portion 214. Therefore, when the sound outlet pipe 11 mounted with the ear cap component 20 is inserted into the ear canal, an area of the sound outlet portion 214 inserted deeper into the ear canal has a smaller outer diameter, which can further reduce the sense of invasion of the ear cap component 20 to the ear canal and improve the in-ear comfort.

It should be further noted that the outer side surface of the sound outlet portion 214 may be a curved surface or an inclined plane, and when the outer side surface of the sound outlet portion 214 is an inclined plane, an angle formed between the outer side surface of the sound outlet portion 214 and the sound outlet direction of the ear cap component 20 may be 15 degrees to 20 degrees, and may be 15 degrees, 17 degrees, 18 degrees, 20 degrees, or the like; when the angle formed between the outer side surface of the sound outlet portion 214 and the sound outlet direction of the ear cap component 20 is too small, a maximum outer diameter of the sound outlet portion 214 is large, thereby causing a strong squeezing to the ear canal; and when the angle formed between the outer side surface of the sound outlet portion 214 and the sound outlet direction of the ear cap component 20 is too large, a maximum outer diameter of the sound outlet portion 214 is too small, the sound outlet channel 212 becomes small, and the sound outlet channel 212 is easily closed when the sound outlet portion 214 is squeezed.

In an example of the present disclosure, the outer diameter of the contact portion 213 decreases along the direction from the contact portion 213 toward the sound outlet portion 214, that is, an area of the contact portion 213 that is closer to the sound outlet portion 214 has a smaller outer diameter, so as to reduce the contact area and the squeezing amount of the contact portion 213 and the ear canal, reduce the sense of invasion of the ear cap component 20 to the ear canal, and improve the in-ear comfort. At this time, the outer diameter of the joint between the contact portion 213 and the sound outlet portion 214 is a minimum outer diameter of the contact portion 213, and the outer side surface of the contact portion 213 may be a curved surface or an inclined plane.

In some examples, the outer diameter of the contact portion 213 may be the same along the direction from the contact portion 213 toward the sound outlet portion 214, so as to improve the airtightness of the ear cap component 20 in the ear canal.

With reference to FIG. 10 again, in some examples of the disclosure, an outer diameter of the joint between the contact portion 213 and the sound outlet portion 214 is d1 that is 6 mm to 7 mm. d1 may be 6 mm, 6.5 mm, 7 mm, or the like. If d1 is too large, it may cause strong squeezing to the ear canal to cause discomfort of the user; if d1 is too small, it may cause a reduced size of the sound outlet 212, and easily cause the sound outlet channel 212 to be closed when the sound outlet portion 214 is squeezed.

With reference to FIG. 10 again, in some examples of the disclosure, the contact portion 213 is in smooth connection with the sound outlet portion 214.

The same or similar reference numbers in the drawings of examples of the present disclosure correspond to the same or similar parts. In the description of the present disclosure, it is to be understood that the terms “upper”, “lower”, “left”, “right”, and the like indicating relationships of directions and positions are based on relationships of directions and positions shown in the drawings, and are intended to be illustrative and simplify descriptions only and not to indicate or imply that the referred device or element must be provided in a particular direction, configured and operated in a particular direction. Therefore the terms used to describe relationships of positions are intended to be illustrative only and are not intended to limit the present disclosure. For those skilled in the art, specific meanings of the above terms can be understood according to specific situations.

The above are only preferred examples of the present disclosure and are not intended to limit the disclosure. Any modifications, equivalent substitutions, improvements or the like within the spirit and principle of the disclosure should be included in the scope of the disclosure.

1. An ear cap applied to an earphone having an earphone body, wherein the earphone body has a sound outlet pipe comprising a sound channel, and an end of the sound outlet pipe is provided with a sound outlet hole in communication with the sound channel; the ear cap comprising:
a main body provided with an accommodating space and a sound outlet channel in communication with the accommodating space, the sound outlet channel being configured to communicate with the sound outlet hole of the sound outlet pipe; and
a noise reduction portion, at least part of which is located in the accommodating space, wherein an outer diameter of the noise reduction portion decreases along a sound outlet direction, forming a noise reduction cavity between an outer side wall of the noise reduction portion and an inner side wall of the main body.

2. The ear cap according to claim 1, wherein an end of the noise reduction portion, distal from the sound outlet channel, abuts against the inner side wall of the main body, or
the end of the noise reduction portion, distal from the sound outlet channel, extends out of the accommodating space, and an end of the main body, distal from the sound outlet channel, abuts against the outer side wall of the noise reduction portion.

3. The ear cap according to claim 1, wherein the main body comprises:
a contact portion having the accommodating space; and
a sound outlet portion connected to the contact portion and having the sound outlet channel,
wherein an end of the noise reduction portion, proximal to the sound outlet channel, is coupled to the sound outlet portion, and the noise reduction cavity is enclosed by the noise reduction portion, the contact portion and the sound outlet portion jointly.

4. The ear cap according to claim 3, wherein the noise reduction portion comprises:
a first noise reduction section coupled to the sound outlet portion; and
a second noise reduction section, which is:
located on the end of the first noise reduction section distal from the sound outlet portion,
connected to the first noise reduction section, and
disposed at an angle relative to the first noise reduction section.

5. The ear cap according to claim 4, wherein the angle formed between an outer side surface of the second noise reduction section and an outer side surface of the first noise reduction section is about 150 degrees to 160 degrees.

6. The ear cap according to claim 3, wherein a joint between the contact portion and the sound outlet portion is concavely recessed inward.

7. The ear cap according to claim 3, wherein the noise reduction portion is integrally formed with the main body.

8. The ear cap according to claim 3, further comprising:
a mounting portion located in the accommodating space and connected to an end of the sound outlet portion proximal to the noise reduction portion, wherein the noise reduction portion is disposed around a peripheral side of the mounting portion.

9. The ear cap according to claim 8, wherein a hardness of a material used for the mounting portion is greater than a hardness of a material used for the main body.

10. An earphone comprising an earphone body and an ear cap, wherein the earphone body has a sound outlet pipe comprising a sound channel, and an end of the sound outlet pipe is provided with a sound outlet hole in communication with the sound channel; and the ear cap comprising:
a main body provided with an accommodating space and a sound outlet channel in communication with the accommodating space; and
a noise reduction portion, at least part of which is located in the accommodating space, wherein an outer diameter of the noise reduction portion decreases along a sound outlet direction, forming a noise reduction cavity between an outer side wall of the noise reduction portion and an inner side wall of the main body,
wherein the sound outlet pipe extends into the accommodating space, the sound outlet hole is in communication with the sound outlet channel, and the noise reduction portion is disposed around a peripheral side of the sound outlet pipe.

11. The earphone according to claim 10, wherein a side of the sound outlet pipe is provided with a pressure relief hole in communication with the sound channel, forming a pressure relief cavity between the noise reduction portion and the sound outlet pipe, and wherein the pressure relief cavity communicates with the sound channel through the pressure relief hole, and the pressure relief cavity has a pressure relief port.

12. The earphone according to claim 11, wherein a support portion is provided between the noise reduction portion and the sound outlet pipe, and wherein the support portion is located in the pressure relief cavity.

13. The earphone according to claim 12, comprising a plurality of supporting portions arranged at intervals around the peripheral side of the sound outlet pipe, and the pressure relief port is formed between two adjacent supporting portions.

14. The earphone according to claim 10, wherein the ear cap further comprises:
a mounting portion located in the accommodating space and connected to an end of a sound outlet portion proximal to the noise reduction portion, wherein the noise reduction portion is disposed around a peripheral side of the mounting portion,
wherein an outer side of the sound outlet pipe is provided with a second clamping groove, and the mounting portion is clamped to the second clamping groove.

15. The earphone according to claim 10, wherein an end of the noise reduction portion, distal from the sound outlet channel, abuts against the inner side wall of the main body; or
an end of the noise reduction portion, distal from the sound outlet channel, extends out of the accommodating space, and an end of the main body, distal from the sound outlet channel, abuts against the outer side wall of the noise reduction portion.

16. The earphone according to claim 10, wherein the main body comprises:
a contact portion having the accommodating space; and
a sound outlet portion connected to the contact portion and having the sound outlet channel,
wherein an end of the noise reduction portion, proximal to the sound outlet channel, is coupled to the sound outlet portion, and the noise reduction cavity is enclosed by the noise reduction portion, the contact portion and the sound outlet portion jointly.

17. The earphone according to claim 16, wherein the noise reduction portion comprises:
a first noise reduction section coupled to the sound outlet portion; and
a second noise reduction section, which is:
located on an end of the first noise reduction section distal from the sound outlet portion,
connected to the first noise reduction section, and
disposed at an angle relative to the first noise reduction section.

18. The earphone according to claim 17, wherein the angle formed between an outer side surface of the second noise reduction section and an outer side surface of the first noise reduction section is about 150 degrees to 160 degrees.

19. The earphone according to claim 16, wherein a joint between the contact portion and the sound outlet portion is concavely recessed inward.

20. The earphone according to claim 16, wherein the noise reduction portion is integrally formed with the main body.
